(19) United States
(12) Patent Application Publication
(10) Pub. No.: US 2002/0076963 A1
(43) Pub. Date: Jun. 20, 2002

(54) Electrical connector

(76) Inventors: Nobuhiro Sugita, Tokyo (JP); Tadahiro Hirasawa, Tokyo (JP)

Correspondence Address: KANESAKA & TAKEUCHI, 1423 Powhatan Street, Alexandria, VA, 22314, US

(21) Appl. No.: 10/012,486

(22) Filed: Dec. 12, 2001

(30) Foreign Application Priority Data
Dec. 18, 2000 (JP) 2000-383155

(51) Int. Cl. H01R 13/64

(52) U.S. Cl. 439/247

(57) ABSTRACT

A pair of connectors (10, 30) each have a housing and the contact sections (19A, 35A) of a plurality of terminals (19, 35) arranged in the arranging area of the housing in the arranging direction, and positioning ridges or grooves (21, 33) provided in the arranging area in the arranging direction for engagement with the positioning grooves or ridges of the mating connector.

### BACKGROUND OF THE INVENTION

1. Field of the Invention

The present invention relates to electrical connectors and, particularly, to electrical connectors enabling to position in the arranging direction of a plurality of terminals.

2. Description of the Related Art

FIG. 6 shows an example of electrical connectors of this type, wherein the positioning portions are provided at opposite sides of the electrical connectors. A pair of guiding posts 53 extend forwardly from a housing 54 outside the arranging area of terminals 51 of a connector 50. Each guiding posts 53 has a conic head 52 and extends forwardly beyond the terminals 51. Another connector 60 has a plurality of terminals 61, which slides on the terminals 51 to contact positions, when the connectors 50 and 60 are plugged together. A pair of guiding holes 62 are provided in the connector 60 outside the arranging area of the terminals to receive the guiding posts 53. The connectors 50 and 60 are positioned with respect to the direction of terminal arrangement by insertion of the guiding posts 53 into the guiding holes 62, and the terminals 51 and 61 are brought into contact with each other at a predetermined position.

The above connectors, however, fails to meet a demand for miniaturized connectors that have many terminals arranged with small pitches. With small pitches, the above positioning mechanism fails to provide positioning with satisfactory precision so that the terminals moves in the widthwise direction, reducing the contact area and preventing smooth sliding contact. The causes for the movement include a need for some play between the guiding posts and holes and the fact that the guiding posts and holes are located outside the terminal arranging area so that the distance between the posts becomes large, making it difficult to make a housing mold with precision. The dimensional errors caused by the above factors have large influence on the small-pitch, multi-pole connectors.

### SUMMARY OF THE INVENTION

Accordingly, it is an object of the invention to provide a pair of electrical connectors enabling to position precisely in the arranging direction of a plurality of terminals and assure smooth contact of the terminals that are arranged with small pitches.

According to the invention there is provided an electrical connector comprising a housing; a plurality of first terminals with contact sections arranged in the housing at predetermined intervals in an arranging direction perpendicular to a plugging direction in which the electrical connector is plugged with a mating connector; and positioning a ridge or ridges or a hole or holes for positioning the connectors with respect to each other in the arranging direction upon plugging by engaging a positioning member or members of the mating connector.

The positions of the positioning ridges or holes are determined precisely in the arranging direction and within the arranging area of the first terminals so that the relative positions of the connectors are kept precisely, assuring smooth contact of the terminals.

The number of positioning ridges or holes may be one, opposite side walls of which serve positioning. The positioning ridges or holes may be provided at a plurality of positions in the arranging direction for higher precision. The positioning ridges or holes may be provided on a pair of opposed surfaces to eliminate effects of inclining plugging of thick connectors. The positioning ridges or holes may be located at different positions on a pair of opposed surfaces in the arranging direction to prevent upside-down plugging.

The housing may be provided with guiding posts or holes for engaging the mating connector with play prior to plugging with the mating connector to help plugging. This allows maximizing the precision of the positioning ridges or holes. The guiding posts may support a second terminal. The first and second type terminals may be signal and power terminals, respectively.

### BRIEF DESCRIPTION OF THE DRAWINGS

FIG. 1 is a top plan view of a pair of first and second connectors according to an embodiment of the invention;

FIG. 2 is a front view of the first connector as viewed from arrows 2-2 of FIG. 1;

FIG. 3 is a front view of the second connector as viewed from arrows 3-3 of FIG. 1;

FIG. 4 is a sectional view taken along line 4-4 of FIG. 1;

FIG. 5 is a perspective view of dovetail tenon and groove according to the second embodiment of the invention; and

FIG. 6 is a perspective view of a pair of conventional connectors.

### DESCRIPTION OF THE PREFERRED EMBODIMENTS

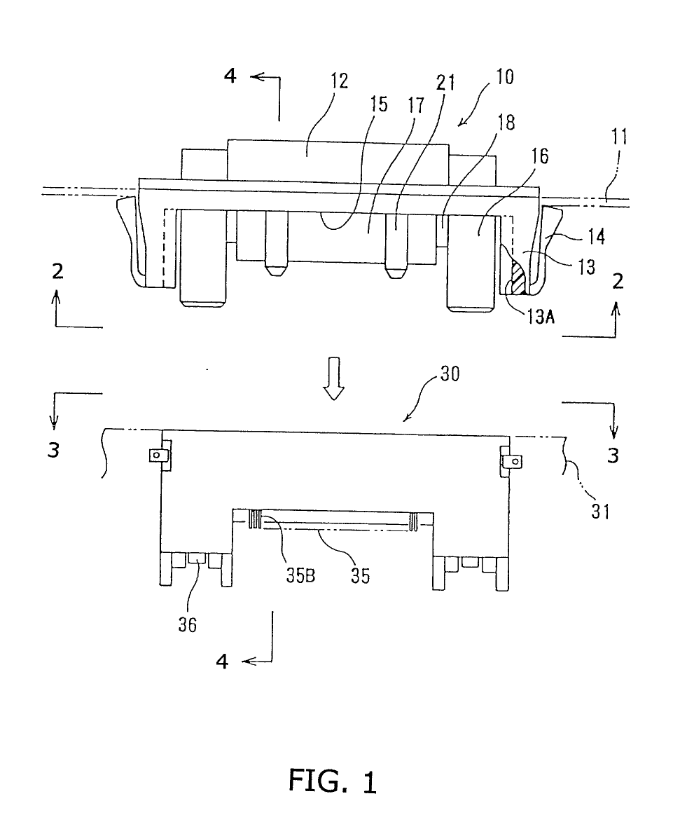

In FIGS. 1-4, a first connector 10 is attached to a panel 11 while a second connector 30 is mounted on a circuit board 31. A housing 12 is made of an insulative material. A pair of flexible arms 14 extend rearwardly from opposite side walls 13 of the housing 12. A recess 15 is defined by the side walls 13. A pair of guiding posts 16 extend forwardly near the insides of the side walls 13, and a rectangular arranging block 17 is provided between the guiding posts 16. A pair of reinforcing sections 18 interconnect the guiding posts 16 and the arranging block 17 for reinforcement.

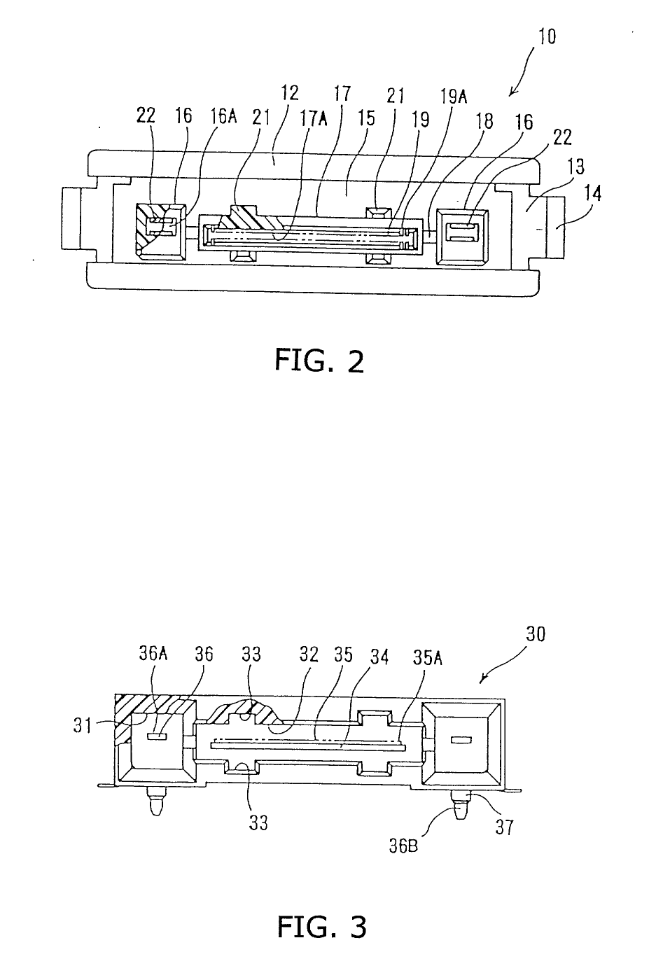

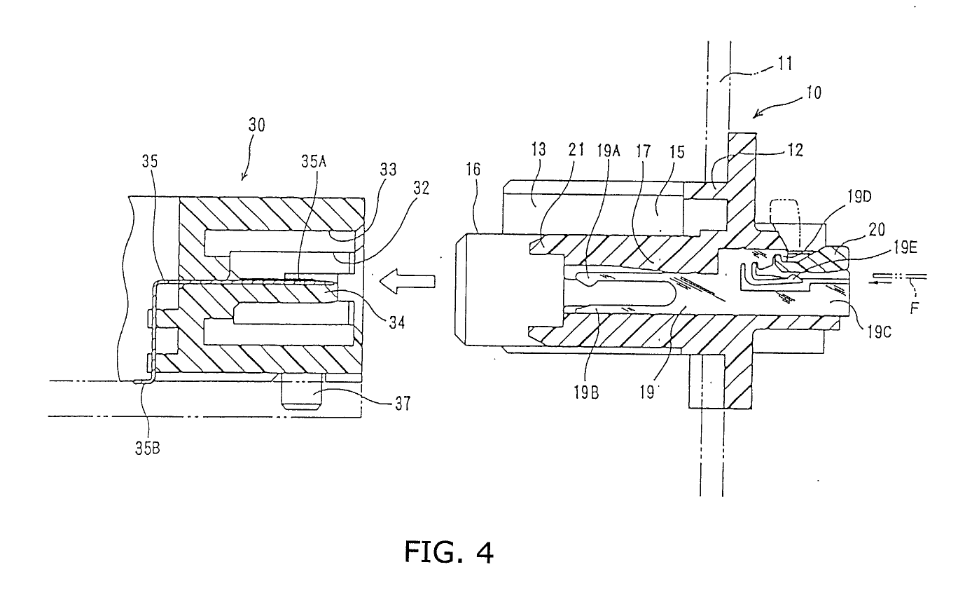

As best shown in FIG. 2, the arranging block 17 has a slot 17A, and a plurality of contact sections 19A of terminals 19 are arranged on the upper face of the slot 17A at predetermined intervals. As shown in FIG. 4, each terminal 19 is made by stamping a predetermined shape from a metal sheet so as to provide a flexible contact section 19A and a support arm section 19B at the front end. Also, it has a fixing section 19C and a hook section 19D at the rear end. A rear contact section 19E is provided between the fixing and hook sections 19C and 19D. A pressure member 20 engages the hook section 19D for rotation. When the pressure member 20 is turned to an open position indicated by dotted line, a flat cable F is inserted in a space between the pressure member 20 and the rear contact section 19E. When the pressure member 20 is turned to a closed position indicated by solid line, the pressure member 20 depresses the flat cable F, bringing it into spring contact with the rear contact section 19E. The shape of the terminal 19 is a mere example, and the invention is not restricted by the shape of a terminal.

A pair of ridges 21 extend forwardly along each of the upper and lower sides of the arranging block 17. The ridges 21 each have a precise width and a precise distance between them in the arranging direction of contact sections 19A. It is preferred that the front end of the ridges 21 are tapered.

As shown in FIGS. 2 and 4, the guiding posts 16 extend beyond the ridges 21 and have a square cross-section and a tapered front end. The guiding post 16 has an opening 16A for housing a terminal 22, which is different from the terminal 19. The terminals 19 and 22 are used as signal and power terminals, respectively. A large number of the signal terminals 19 are arranged at very small intervals. The illustrated terminals 22 are of the female type. The shape of the terminals 22 is not relevant to the present invention and may take other forms.

The connector 30 is made such a shape and size that it is housed in the space defined by the recess 15 and the accommodation steps 13A provided in the side walls 13. As shown in FIGS. 2-4, the connector 30 has a pair of guiding openings 31 at opposite sides and a plugging cavity 32 at the center of the housing to receive the guiding posts 16 and the arranging block 17, respectively, when both the connectors are plugged together.

A pair of grooves 33 are provided in each of the upper and lower faces of the plugging cavity 32 to receive the ridges 21 of the connector 10. The grooves 33 and the ridges 21 are made in such dimensions that they assure their relative position in the arranging direction (lateral direction in FIGS. 2-3). By contrast, the guiding posts 16 are plugged in the guiding holes 31 with play. The connector 30 has an arranging plate 34 inside the plugging cavity 32, and the contact sections 35A of a plurality of terminals 35 are arranged on an upper face of the arranging plate 34 at regular intervals. The contact sections 35A correspond to the contact sections 19A of the connector 10 in the arranging direction. The contact section 36A of a flat male terminal 36 is provided in each guiding hole 31 and makes contact with the female terminal 22 of the connector 10. Since the guiding posts 16 are inserted in the guiding holes 31 with play in the arranging direction, each of the terminals 22 and 36 has a relatively wide flat contact surface to absorb the widthwise displacement caused by the play.

The terminals 35 and 36 are made signal and power terminals, respectively, corresponding to the mating connector 10. The terminals 35 each have a connection section 35B exposed from the rear face of the housing and the terminals 36 each has a connection section 36B projecting downwardly from the bottom of the housing. Also, a pair of positioning studs 37 extend downwardly from the bottom of the housing.

### How to use such connectors will be described.

(1) The connectors 10 and 30 are attached to a panel 11 and a circuit board 31, respectively. The connector 30 is attached to the circuit board 31 such that the connection sections 35B and 36B of the terminals 35 and 36 are soldered to the corresponding traces of the circuit board 31.

(2) The pressure member 20 of the connector 10 is turned to the open position, and the flat cable F is placed on the contact sections 19E of the terminals 19, and the pressure member 20 is turned to the closed position, bringing the flat cable F into spring contact with the contact sections 19E.

(3) The connectors 10 and 30 are plugged together. The incorporated play makes it easy to plug the guiding posts 16 of the connector 10 in the guiding holes 31 of the connector 30. As the plugging advances, the power terminals 22 and 36 start contact with each other.

(4) As the plugging further advances, the arranging block 17 of the connector 10 and the plugging cavity 32 of the connector 30 start to plug together. Since the ridges 21 of the arranging block 17 and the grooves 33 of the plugging cavity 32 each have a precise width, the plugging is made precisely widthwise in the arranging direction. As a result, even if the signal terminals 19 and 35 of the connectors 10 and 30 are arranged with a narrow pitch, they make precise, smooth contact.

(5) When the plugging is completed, the signal terminals 19 and 35 and power terminals 22 and 36 are connected smoothly. The fact that the power terminals are connected prior to the signal terminals is desirable for the circuit.

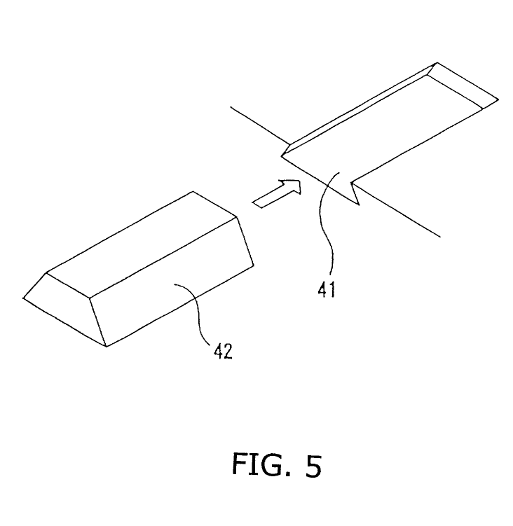

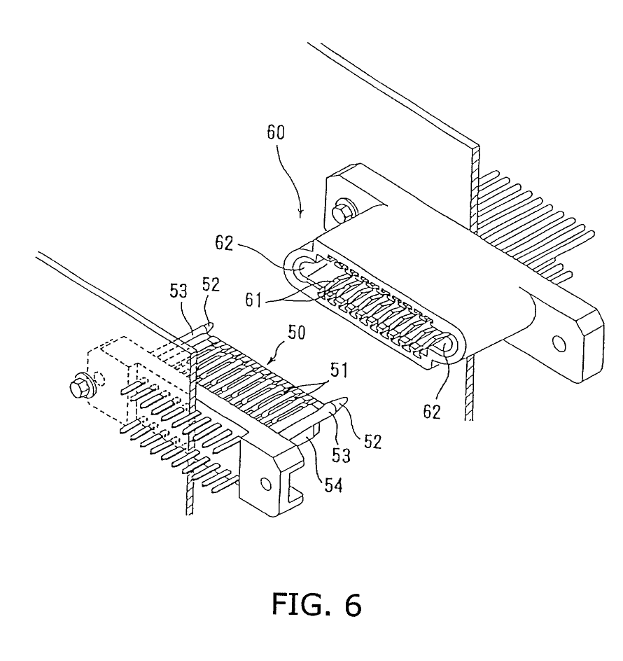

In FIG. 5, the positioning ridge provided on the arranging block in the above embodiment is replaced by a dovetail tenon 42 which is inserted into a dovetail groove 41 provided in the housing. The number of pairs of groove and tenon provided may be one but two or more pairs are preferred for higher precision. The positioning is made for contact sections so that it is important to provide positioning members inside the arranging area of the contact sections.

Referring back to FIGS. 1-4, it is preferred that the ridges and grooves are provided on the upper and lower faces of the connectors so that even if the connectors are thick (high), producing an error in the thicknesswise direction, the widthwise precision of plugging is kept high.

The upside-down plugging may be prevented by providing the ridges and grooves at different positions on the upper and lower faces.

As has been described above, the positioning ridges and grooves are provided in the arranging area of terminals so that the dimensional error of the molded housing is minimized, meeting a demand for a pair of connectors having narrow-pitch, multi-pole terminals and assuring smooth contact.

1. An electrical connector comprising:
a housing;
a plurality of first terminals with contact sections arranged in an arranging area of said housing at predetermined intervals in an arranging direction perpendicular to a plugging direction in which said electrical connector is plugged with a mating connector; and
positioning means for positioning said connectors with respect to each other in said arranging direction upon plugging by engaging a positioning member or members of said mating connector,
said positioning means provided in said arranging area in said arranging direction.

2. The electrical connector according to claim 1, wherein said positioning means are provided at a plurality of positions in said arranging direction.

3. The electrical connector according to claim 1, wherein said positioning means are provided on a pair of parallel surfaces opposed upon plugging.

4. The electrical connector according to claim 3, wherein said positioning means are provided at different positions on said opposed parallel surfaces in said arranging direction.

5. The electrical connector according to claim 1, wherein said housing is provided with guiding means for engaging said mating connector with play prior to plugging with said mating connector.

6. The electrical connector according to claim 5, wherein said guiding means supports a second terminal

7. The electrical connector according to claim 6, wherein said first and second type terminals are signal and power terminals, respectively.
